(19) United States
(12) Patent Application Publication
(10) Pub. No.: US 2005/0240770 A1
(43) Pub. Date: Oct. 27, 2005

(54) System, method and computer-readable medium to issue an electronic signature in association with a checksum of a document

(76) Inventors: Kathleen Lane, Los Altos Hills, CA (US); William Hustacls Lane, Los Altos Hills, CA (US)

Correspondence Address: PATRICK REILLY, BOX 7218, SANTA CRUZ, CA, 95061-7218, US

(21) Appl. No.: 10/874,800

(22) Filed: Jun. 22, 2004

Related U.S. Application Data
(60) Provisional application No. 60/482,055, filed on Jun. 23, 2003.

(51) Int. Cl. H04L 9/00

(52) U.S. Cl. 713/176

(57) ABSTRACT

The incorporation of checksum and voice files for off line participants to work in an electronic work space. The electronic signatures, and/or completion of, off line documents enables the contents of off line documents to be stored and processed in the same manner as on line users. The invented process links the process steps of on line participants and offline participants, and additionally meets, in certain preferred embodiments of the method of the present invention, the requirements of one or more industry and/or legal standards for electronic signatures, to include the requirements of assured Integrity, Authenticity, Non-Repudiation and Acceptance.

### RELATED PROVISIONAL PATENT APPLICATION

This application for patent is a continuation of U.S. Provisonal Patent Application Ser. No. 60/482,055, filed on Jun. 23, 2003, entitled “System and method to issue an electronic signature in association with a checksum of a document”, and this application claims benefit of the filing date thereof. The U.S. Provisonal Patent Application Ser. No. 60/482,055 is wholly integrated by reference into and with this application

### FIELD OF THE INVENTION

The present invention relates to electronic signatures related or appended to the certification or authorization of documents. More particularly, the present invention relates to methods of forming and recording electronic signatures.

### BACKGROUND OF THE INVENTION

Signatures of authorized and or recognized persons are often associated or appended to documents assure one or more aspects or qualities of a document, information, and/or a data file, to optionally include the following aspects or qualities:
Document Integrity: an assurance that neither data contained within the document nor the document itself has neither (1) been altered after a signer has signed the document, nor (2) been altered prior to receipt by a second party, such as a recording office of a government agency;
Document Authenticity: a high degree certainty that a document actually was transmitted by an indicated sender;
Non-Repudiation: an evidentiary quality of a document supportive of a claim that a sender of the document transmitted or presented the document in a given state, the evidence sufficient to reduce the credibility of a later repudiation by the sender of the transmission or presentation of the document; and
Binding Acceptance: an act of signing a document that creates a contract by proof of acceptance of a valid offer.

The use and acceptance of electronic signatures in place of written signatures to certify or authorize information, documents, and data files the traditional hand written signatures of financial, legal, medical and business documents. Furthermore, electronic automated business processes often utilize electronic signature processes that require signing parties to provide electronic signatures while on line with a computer or communications network, such as the Internet. Although various types of e-signature processes are known in the art and recognized as valid e-signature methods, many potential issuers of electronic signatures are not willing to go on line in order to issue an electronic signature. In addition, although an automated business process may be in place, there are instances where potential participants in an electronic workflow do not have sufficient access to the Internet to consistently or always perform an electronic signature process by direct Internet input.

It is an object of certain preferred embodiments of the method of the present invention to provide a method or system to address a long felt need to enable a signer to issue an electronic signature to a document while the signer is not directly on line with a particular computer or communications network at the moment the signature process is initiated by the signer.

### SUMMARY OF THE INVENTION

These and other objects will be apparent in light of the prior art and this disclosure. The present invention provides a method and system that optionally define a process where by an automated workflow can communicate with a participant. The communication may optionally occur in certain preferred embodiments of the method of the present invention in an offline manner and yet provide a process for such offline participant, or offline signer, to use an e-signature method that provides the substantially the same integrity, authenticity, quality of non-repudiation, and/or acceptance of other workflow participants as if the offline participant or signer was part of the on line workflow.

In a first preferred embodiment of the method of the present invention, a signer is presented with a document containing information presented by means of characters, such as alphabetic characters, numeric characters, ideograms, glyphs, Braille characters, and/or other suitable characters representing information known in the art, in singularity or in combination. The signer may then review the information by reading or feeling the characters. Where the signer wishes to certify the document, or note that he or she has read the document, the signor may input a voice record into an electronic recording system to generate an electronic record of the signer's act of certification, authorization, or mere acknowledgement of possessing the document or a copy of the document. The electronic record may optionally be associated with or appended to a database record, wherein the database record contains some or all of the information presented in the document when the document was delivered to the signer. The electronic record may be a digital record of an audio file, such as a wave record, or a .WAV record, or another suitable record storable in an electronic medium.

In a second preferred embodiment of the method of the present invention, the document is presented to the signer with a checksum, where the checksum has been calculated on the basis of some or all of the information contained in the document, and optionally in combination with information related to the format of the document, or a serial number of the document, and/or other information related to or extraneous to the information contained in the document. The checksum may be the sum, or be related to the sum of a group of data items, wherein the checksum is used for checking purposes to insure that the information is not corrupted or altered after the signer has reviewed the information of the document. The checksum may be stored or transmitted with the information and or a group of data items. The checksum may be calculated by treating the information and/or other data items as numeric values. The checksum is useful in certain suitable methods known in the art for data error detecting and correcting. The checksum may optionally be computer as a value and arrived at via a suitable parity or hashing algorithm known in the art, on information requiring protection against error or manipulation. The checksums may be stored or transmitted with the information, the document, and/or other data items and are intended to detect data integrity problems.

In a third preferred embodiment of the method of the present invention, a first party faxes a document to a certifying party. The document includes information. The first party also communicates a checksum to the certifying party, wherein the checksum is at least partly derived on all or some of the information of the document. The certifying party then reviews the document and the information to determine the accuracy of the information, or confirm a willingness of the certifying party to issue an electronic signature to the document with the information as presented in the fax of the document. The certifying party may issue the electronic signature by placing a telephone call to an electronic recording system, whereby an electronic record is made by the electronic recording system of a voice input of the certifying party. The voice input may contain a verbalization of the checksum, a serial number of the document, and/or a personal identification number of the certifying party. Optionally, personal identification numbers may be issued to only registered users of a given process or business system. The certifying authority may enter some of the information by means of telephone tones or other suitable methods of information transfer via telephony known in the art. The electronic record may then be transferred to an electronic database via a computer-readable media, and the electronic record may be associated with or appended to a data record of the document or the information of the document.

In a fourth preferred embodiment of the method of the present invention, a funeral director, or other authorized person, may fax or otherwise deliver a hard copy of a death certificate to the certifying authority, i.e., a medical doctor, or other person, authorized to certify death certificates, wherein the death certificate presents information identifying a deceased person and a probable cause of death of the deceased person. The funeral director may optionally and additionally provide a checksum, a serial number of the document to the certifying party, where the checksum is at least partly derived on the basis of some or all of the information presented in the death certificate, to optionally include identity data and a cause of death finding. If the certifying authority decides to electronically sign the document as the document was faxed or delivered to the certifying authority, the certifying authority may place a phone call to an electronic recording system, whereby an electronic record is made by the electronic recording system of a voice input of the certifying party. The voice input may contain a verbalization of the checksum, a serial number of the death certificate, and/or a personal identification number of the certifying party. The certifying authority may enter some of the information by means of telephone tones or other suitable methods of information transfer via telephony known in the art. The electronic record may then be transferred to an electronic database via a computer-readable media, and the electronic record may be associated with or appended to a data record of the death certificate or the information of the death certificate. Optionally, a first participant may be on line and route a partially completed document to an offline participant with a first checksum of the information of the partially completed document. The first checksum may optionally be derived from the information of the partially completed document, a record serial number, and/or an identification number of the first participant. The certifying party may then add information manually to the partially complete document and then transmit or fax the partially completed document with additional information back to the first participant. The first participant may then match the document as transmitted or faxed with a database record of the partially completed document, wherein this step may be automated within a business process software program, and the first participant or a software process may include the additional information in the database record of the document.

The term “computer-readable medium” as used herein refers to any suitable medium known in the art that participates in providing instructions to the network for execution. Such a medium may take many forms, including but not limited to, non-volatile media, volatile media, and transmission media. Non-volatile media includes, for example, optical or magnetic disks, such as storage device 10. Volatile media includes dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the network for execution. For example, the instructions may initially be carried on a magnetic disk of a remote computer. The remote computer can load the instructions into its dynamic memory and send the instructions over a telephone line using a modem. A modem local to or communicatively linked with the network can receive the data on the telephone line and use an infra-red transmitter to convert the data to an infra-red signal. An infra-red detector can receive the data carried in the infra-red signal and appropriate circuitry can provide the data to the network.

Other aspects of the present invention include an apparatus and a computer-readable medium configured to carry out the foregoing steps. The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which: These, and further features of the invention, may be better understood with reference to the accompanying specification and drawings depicting the preferred embodiment, in which:

FIG. 1 is a schematic including a computer network and telephonic means by which the first, second, third, and fourth preferred embodiments of the method of the present invention may be carried out.

FIG. 2 is a process flow chart of the fourth preferred embodiment of the present invention, wherein the computer network and telephonic means of FIG. 1 are utilized.

FIG. 3 work process that comprises an optional third software program that provides an offline data collection and digital signature confirmation process FIG. 4 is a schematic of an approval of e-signature(s) of an off line participant(s) in an automated business process.

FIG. 5 is an illustration that describes how the integrity of an electronic signature is assured or confidence is raised in, wherein the method of FIG. 5 is in accordance with certain alternate preferred embodiments of the method of the present invention.

FIG. 6 is an illustration that describes how a confidence that a certain document was issued by a certain sender may be improved or authenticated.FIG. 7 is an illustration that describes a method to impose non-repudiation upon the sender of a document or of the informational content of the document, wherein the method of FIG. 7 is in accordance with certain alternate preferred embodiments of the method of the present invention.

FIG. 8 is an illustration that FIG. 8 describes a method whereby the signer documents his or her acceptance of an offer, wherein the method of FIG. 8 is in accordance with certain yet alternate preferred embodiments of the method of the present invention.

FIG. 9 provides a method for capturing and storing handwritten signatures.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

Referring now generally to the Figures and particularly to FIG. 11, a communications network 2 includes the Internet 4, a computer-readable media 6, a computer workstation 8, an electronic audio recording and storing module 9, and a fax system 10. The workstation 8 is communicatively linked to the Internet 4 and the fax system 10. A first party, such as a funeral director, may transmit a document 12, such as an uncertified death certificate, via the fax system 10 to a second fax system 14 to a certifying party, or informant, such as a medical doctor authorized to certify a death certificate or other document. The certifying authority may review an information presented in a fax copy 15 of the document 12 as received and printed by the second fax system 14, along with a checksum, a document serial number and/or a personal identification number. The certifying party may issue an electronic signature 16 for the document 12 by placing a phone call via a telephone 17 to an electronic recording system 18. The electronic audio recording and storing module 9 may receive an audio input, such as a verbal statement by the informant, that is provided via the telephone 17 and then store the audio input as an electronic audio record. The electronic recording system 18 may generate an electronic digital record 20 of the phone call made by the certifying authority, and the digital record may be transmitted to a record computer workstation 22 by means of the Internet 4 or the computer-readable media 6. The record computer workstation 22, or record workstation 22, may store the digital record 20 in a database 24, and wherein some or all of the information of the document 12 is stored in a database record 26 and the database record 26 is associated with the electronic signature as issued by the certified party and memorialized by means of the digital record 20. The telephone 17 may communicate with the electronic recording system 18 via the communications link 28, wherein the link 28 may be or comprise a communications cable, a telephone land line, a wireless link, a wireless communications equipment, or other suitable communications means known in the art. The fax system 10 may optionally be comprised within the workstation 8, and may communicate with the second fax system 14 via the communications link 30, wherein the link 30 may be or comprise a communications cable, a telephone land line, a wireless link, a wireless communications equipment, or other suitable communications means known in the art.

In a first preferred embodiment of the method of the present invention, a signer is presented with the document 12 containing information presented by means of characters, such as alphabetic characters, numeric characters, ideograms, glyphs, Braille characters, and/or other suitable characters representing information known in the art, in singularity or in combination. The signer may then review the information by reading or feeling the characters. Where the signer wishes to certify the document 12, or note that he or she has read the document 12, the signor may input a voice record into the electronic recording system 18 to generate the electronic digital record 20 of the signer's act of certification, authorization, or mere acknowledgement of possessing the document 12 or a copy 15 of the document 12. The electronic digital record 20 may optionally be associated with or appended to a database record, wherein the database record 26 contains some or all of the information presented in the document 12 when the document 12 was delivered to the signer. The electronic record 20 may be a digital record of an audio file, such as a wave record, or a .WAV record, or another suitable record storable in an electronic medium.

The communications network 2 may further comprise the electronic audio recording and storing module 9, the second fax system 14, the telephone 17, electronic recording system 18, and the record workstation 22.

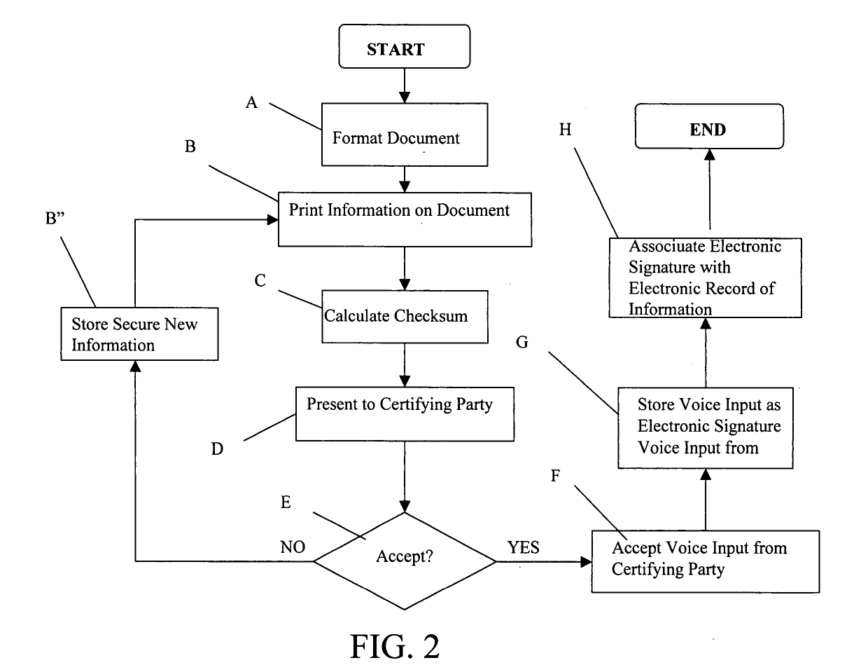

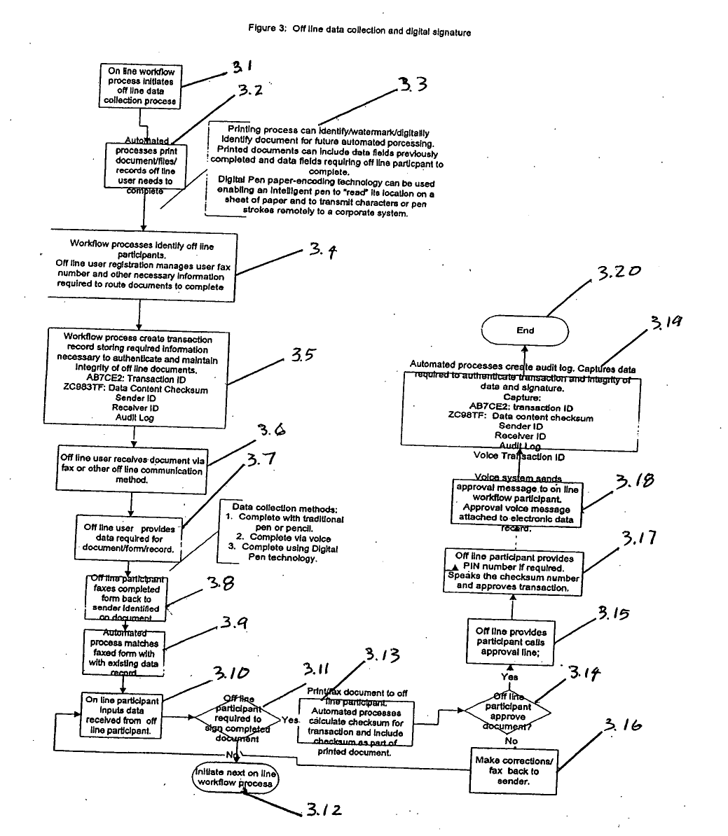

Referring now generally to the Figures and particularly to FIG. 2, a method to execute certain alternate preferred embodiments of the present invention is described in FIG. 2. In a Step A the document is formatted. The format of the document may be an unformatted page, area, or matrix, or the format of the document might be highly formatted, such as a format outlined or approved by a government or a corporate entity, such as a death certificate format as authorized or acceptable to a government agency. In Step B the information is printed onto the document, such as by writing, or printing press, or in Braille characters, or by another suitable method known in the art of creating sensually detectable characters. In a Step C the checksum is calculated, where the checksum is at least partly derived from the printed characters of the all or part of the characters that present the information for review by the certifying party. In a Step D the document and the checksum are presented to the certifying party. The document and/or the checksum may be provided as a hard copy, or as a fax, or by another readable or sensually discernable and suitable form known in the art. The certifying party may then observe the document and the information as presented in the document, e.g., by reading or feeling the printed characters. The certifying party may then decide in Step E whether to certify, or to reject and not certify the document. Or the certifying party may elect to certify the document by executing a Step F, wherein the certifying makes a voice input to the electronic recording system 18 by verbally stating the checksum and optionally the document serial number and a personal identification number. In Step G the electronic recording system 18 accepts the voice input from the certifying party and issues the electronic record of the voice input as the electronic signature record 20. In a Step the electronic signature record 20 is associated with, or comprised within, or appended to, the electronic record 12 of the document or information in the database 24.

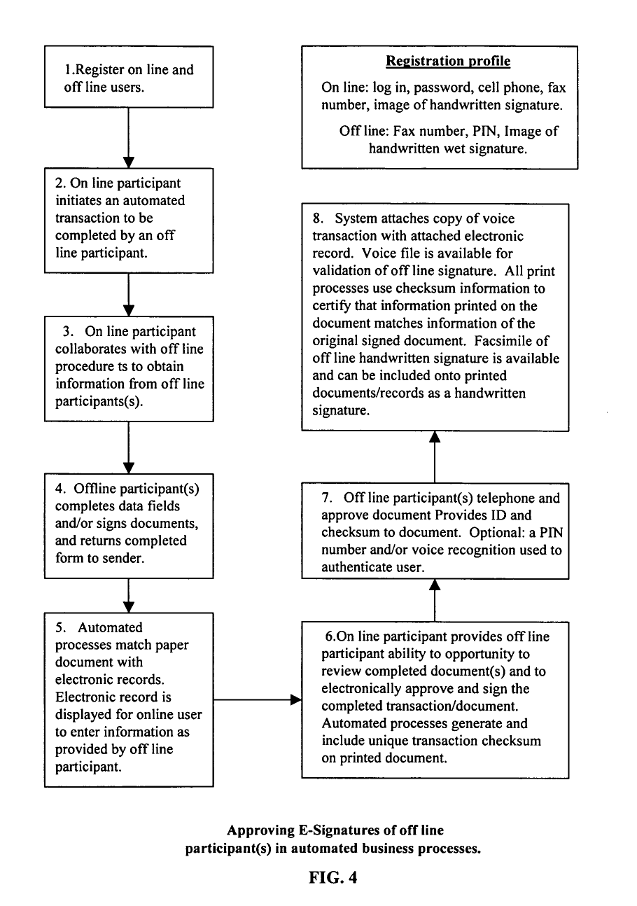

Referring now generally to the Figures and particularly to FIG. 3, FIG. 3 presents an optional work process that comprises an optional third software program that provides an offline data collection and digital signature confirmation process of the method of the present invention, wherein an on line workflow process initiates an off line data collection process in Step 3.1 of this optional aspect of the method of the present invention. It is understand that an on line process as defined within this disclosure includes a process that accepts or transmits information, or permits the access of information via the communications network 2 It is further understood that the terms document, form and record are synonymous in this disclosure and may describe software records, hard copy record, or both. In step 3.2 an automated process of the communications network 2, or an element or elements thereof, performs an automated process that documents and optionally files and or records a user record, or first record, that is provided information by an offline user, or informant. The record may be documented stored recorded and filed as either a hard copy or a soft copy, or both. Where the first record is embodied, either in the original or as a copy, as a hard copy document a printing step 3.3 of the optional method of FIG. 3 enables (1) watermarking a material upon which the document is printed, e.g. paper, (2) printing documents with information as stored in the communications network 2, whereby the document provides open fields for the user to enter additional information onto the document, and/or (3) providing the user with a digital pen module, wherein the digital pen module is communicatively linked to the communications network 2, or an element or elements thereof, and the digital pen enables recording of the motions of the pen for storage in a soft copy of the document. In step 3.4 the participants of the process are identified and the offline user registration is enabled and by an optional software module of the third software program. In step 3.5 transaction information is stored. In step 3.6 the informant receives the document via fax or other offline communication method, e.g. a mailing or delivery by messenger. In step 3.6 the informant provides data to the document. In step 3.7 the informant provides information to the document. In 3.8 the informant completes the form and faxes the document back to a sender of the document, originator of the document, or other party. It is understood that the informant may merely add information to the document in step 3.7, rather than perfecting or completing a document by providing all information required to complete the document, but rather may provide merely one datum of information to the document. In step 3.9 the automated process of the third software program matches the faxed document with an existing data record as stored within the communications network 2, or an element or elements thereof. In step 3.10 an on line participant in the process inputs data to a software record, wherein the data is derived from the information included in the form as faxed in step 3.8. In step 3.11 the third software program determines if the informant, or other off line participant, is required to sign the document or form. If the determination of step 3.11 is negative, then the third software program initiates, or waits until directed to initiate, another work flow process according to the alternate preferred method of the invention of FIG. 3 as indicated in step 3.12. In step 3.13, and where the determination of system 3.11 is that the informant, or other offline participant, is required to sign the document, then the third software program calculates a checksum for the transaction and includes a printing or representation of the checksum on the printed document provided to the informant or other offline participant. In step 3.14 the informant or other participant in the off line process either (1) approves the document with the checksum and the work flow moves onto step 3.15, or fails to approve the document, wherein the workflow process moves on to step 3.16. In step 3.16 the informant or other offline participant may correct the document in writing or other method of adding, deleting or correcting information to the hard copy document and transmit the document by fax to the sender, originator or other participant in the process, and the work flow process returns to step 3.10. In step 3.17 the informant or other offline participant communicates approval to the on line participant, by means of telephony equipment or other suitable means known in the art. In step 3.18 the informant or other off line participant optionally audibly states an approval message, that includes a pin number and/or the checksum number and approval of the document by the informant or other off line participant as newly modified or completed, into an audio receiver, such as the telephone 17, wherein an electronic record of the statement made by the informant or other offline participant is recorded as an electronic audio record, and the electronic audio record is associated with a software record of, or associated with, the document processed by the alternate preferred embodiment of the present invention of FIG. 3. It is understood that the telephone 17 may communicate via a land line or physical communications line or cable, or by wireless transmission, to the communications network 2 in various alternate preferred embodiments of the method of the present invention. The audio record may be stored in the communications network 2, or element or elements thereof such as the electronic audio recording module 9. In step 3.19 the communications network 2 provides the approval message to the on line participant for association with a software record comprising or associated with at least some the information of the document, or optionally for automated association by the third software program of a software representation of the approval message. In step 3.20 the third software creates an audit log wherein data required to authenticate the approval of the document of the method of FIG. 3. Referring now generally to the Figures and particularly to FIG. 4, FIG. 4 is an illustration of an of an approval of e-signature(s) of an off line participant(s) in an automated business process.

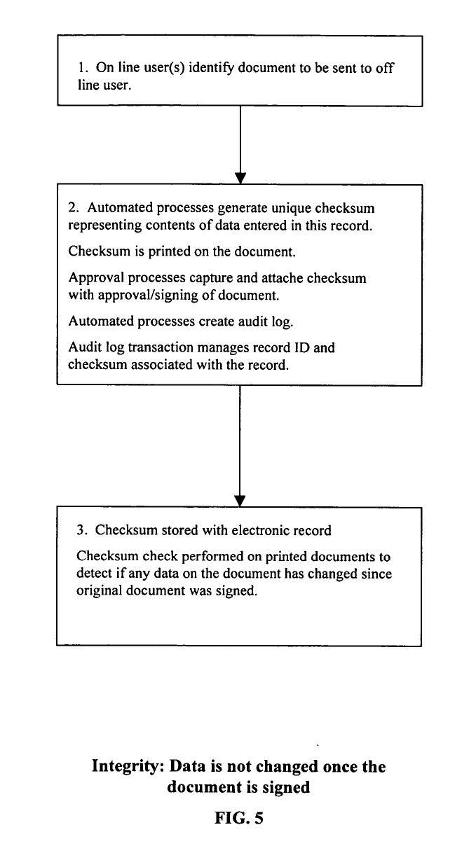

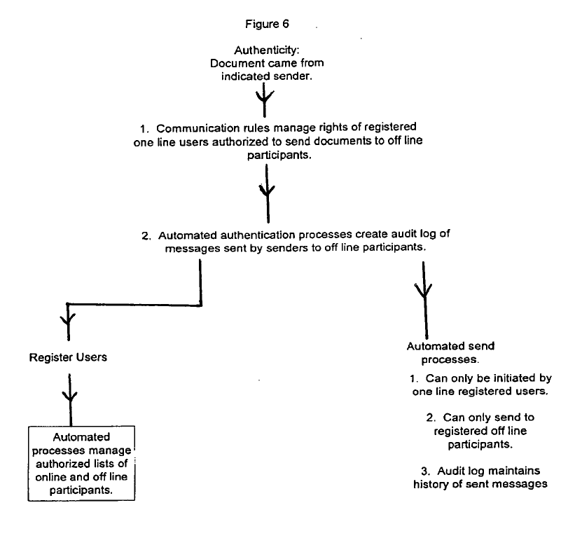

Referring now generally to the Figures and particularly to FIG. 5, FIG. 5 describes how the integrity of an electronic signature is assured or confidence is raised in, wherein the method of FIG. 5 is in accordance with certain alternate preferred embodiments of the method of the present invention.

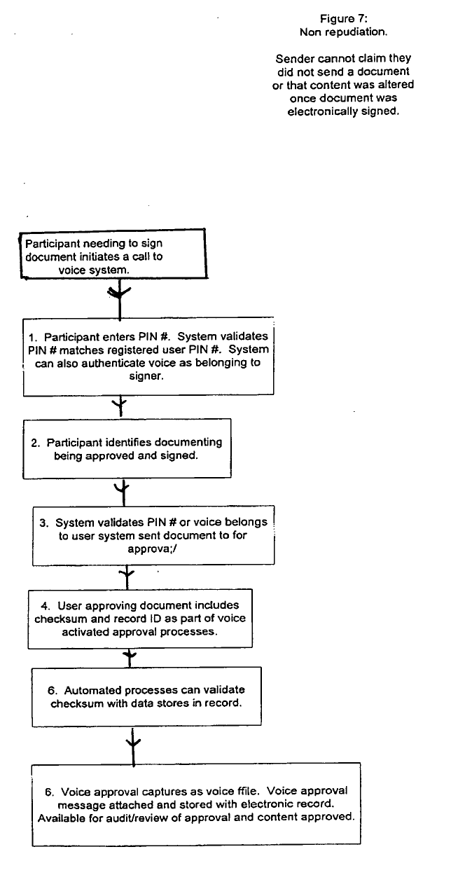

Referring now generally to the Figures and particularly to FIG. 6, FIG. 6 describes how a confidence that a certain document was issued by a certain sender may be improved or authenticated.

Referring now generally to the Figures and particularly to FIG. 7, FIG. 7 describes a method to impose non-repudiation upon the sender of a document or of the informational content of the document, wherein the method of FIG. 7 is in accordance with certain alternate preferred embodiments of the method of the present invention.

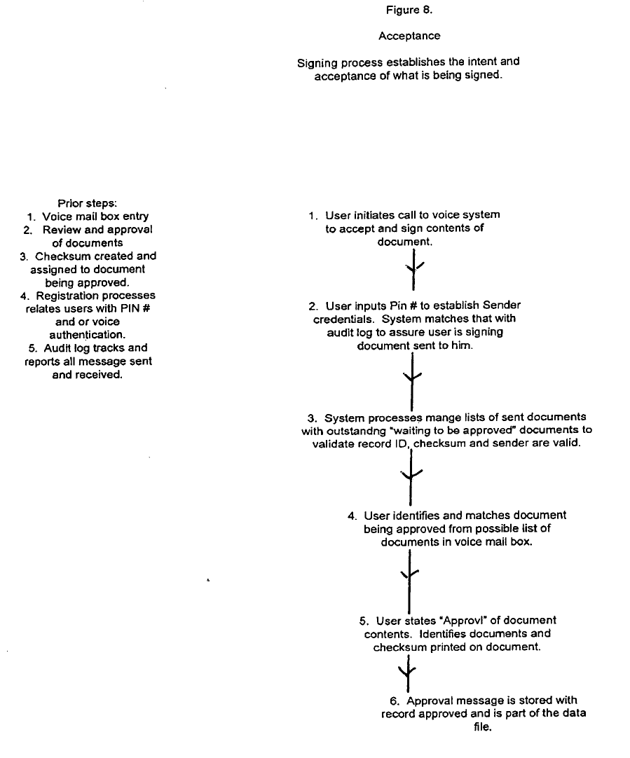

Referring now generally to the Figures and particularly to FIG. 8, FIG. 8 describes a method whereby the signer documents his or her acceptance of an offer, wherein the method of FIG. 8 is in accordance with certain yet alternate preferred embodiments of the method of the present invention.

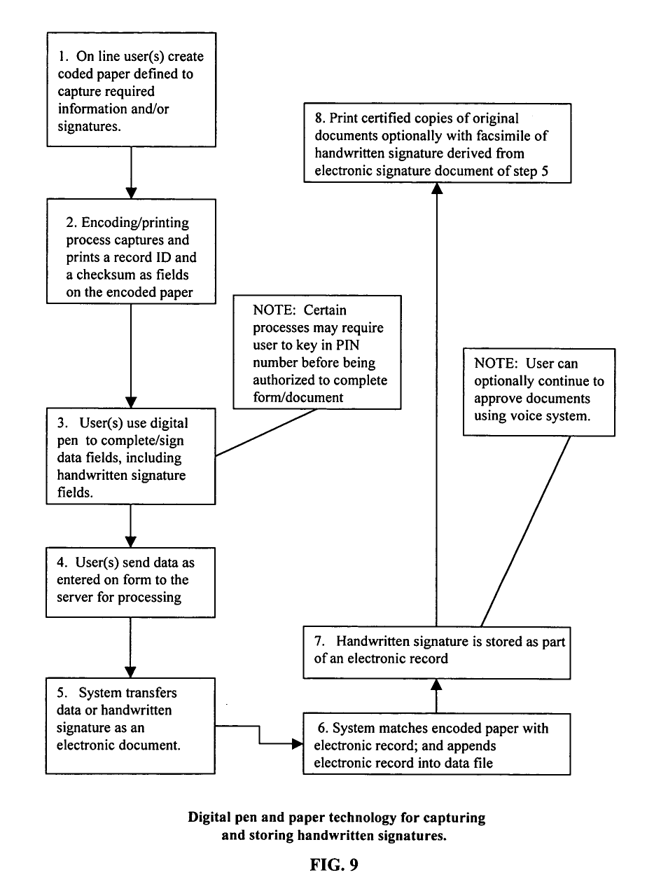

Referring now generally to the Figures and particularly to FIG. 9, FIG. 9 provides a method for capturing and storing hand written signatures.

In a second preferred embodiment of the method of the present invention, the document 12 is presented to the signor with a checksum, where the checksum has been calculated on the basis of some or all of the information contained in the document 12, and optionally in combination with information related to the format of the document 12, or a serial number of the document, and/or other information related to or extraneous to the information contained in the document 12. The checksum may be the sum, or be related to the sum of a group of data items, wherein the checksum is used for checking purposes to insure that the information is not corrupted or altered after the signer has reviewed the information of the document 12. The checksum may be stored or transmitted with the information and or a group of data items. The checksum may be calculated by treating the information and/or other data items as numeric values. The checksum is useful in certain suitable methods known in the art for data error detecting and correcting. The checksum may optionally be computer as a value and arrived at via a suitable parity or hashing algorithm known in the art, on information requiring protection against error or manipulation. The checksums may be stored or transmitted with the information, the document 12, and/or other data items and are intended to detect data integrity problems.

In a third preferred embodiment of the method of the present invention, a first party faxes a document 12 to a certifying party. The document 12 includes information. The first party also communicates a checksum to the certifying party, wherein the checksum is at least partly derived on all or some of the information of the document. The certifying party then reviews the document 12 or a copy 15 of the document 12 and the information to determine the accuracy of the information, or confirm a willingness of the certifying party to issue an electronic signature 16 to the document 12 with the information as presented in the fax 14 of the document 12. The certifying party may issue the electronic signature 16 by placing a telephone call via the telephone 17 to the electronic recording system 18, whereby the electronic record 20 is made by the electronic recording system 18 of a voice input of the certifying party. The voice input may contain a verbalization of the checksum, a serial number of the document 12, and/or a personal identification number of the certifying party. Optionally, personal identification numbers may be issued to only registered users of a given process or business system. The certifying authority may enter some of the information by means of telephone tones or other suitable methods of information transfer via telephony known in the art. The electronic record 20 may then be transferred to the electronic database 24 via the computer-readable media 6, and the electronic record 20 may be associated with or appended to a data record 26 of the document 12 or the information of the document 12.

In a fourth preferred embodiment of the method of the present invention, a funeral director, or other authorized person, may fax or otherwise deliver a hard copy 15 of a death certificate 11 to the certifying authority, i.e., a medical doctor, or other person, authorized to certify death certificates, wherein the death certificate 11 presents information identifying a deceased person and a probable cause of death of the deceased person. The funeral director may optionally and additionally provide a checksum, a serial number of the document 11 to the certifying party, where the checksum is at least partly derived on the basis of some or all of the information presented in the death certificate 11, to optionally include identity data and a cause of death finding. If the certifying authority decides to electronically sign the document 12 as the document 12 was faxed or delivered to the certifying authority as the copy 15, the certifying authority may place a phone call to the electronic recording system 18, whereby the electronic record 20 is made by the electronic recording system 18 of a voice input of the certifying party. The voice input may contain a verbalization of the checksum, a serial number of the death certificate, and/or a personal identification number of the certifying party. The certifying authority may enter some of the information by means of telephone tones or other suitable methods of information transfer via telephony known in the art. The electronic record 20 may then be transferred to the electronic database 24 via the computer-readable media 6, and the electronic record 20 may be associated with or appended to the data record 26 (1) of the death certificate 11, or (2) containing at least some of the information of the death certificate 11. Optionally, a first participant may be on line and route a partially completed document 11 to an offline participant with a first checksum of the information of the partially completed document. The first checksum may optionally be derived from the information of the partially completed document, a record serial number, and/or an identification number of the first participant. The certifying party may then add information manually to the partially complete document and then transmit or fax the partially completed document with additional information back to the first participant. The first participant may then match the document as transmitted or faxed with a database record 20 of the partially completed document, wherein this step may be automated within a business process software program, and the first participant or a software process may include the additional information in the database record 20 of the document.

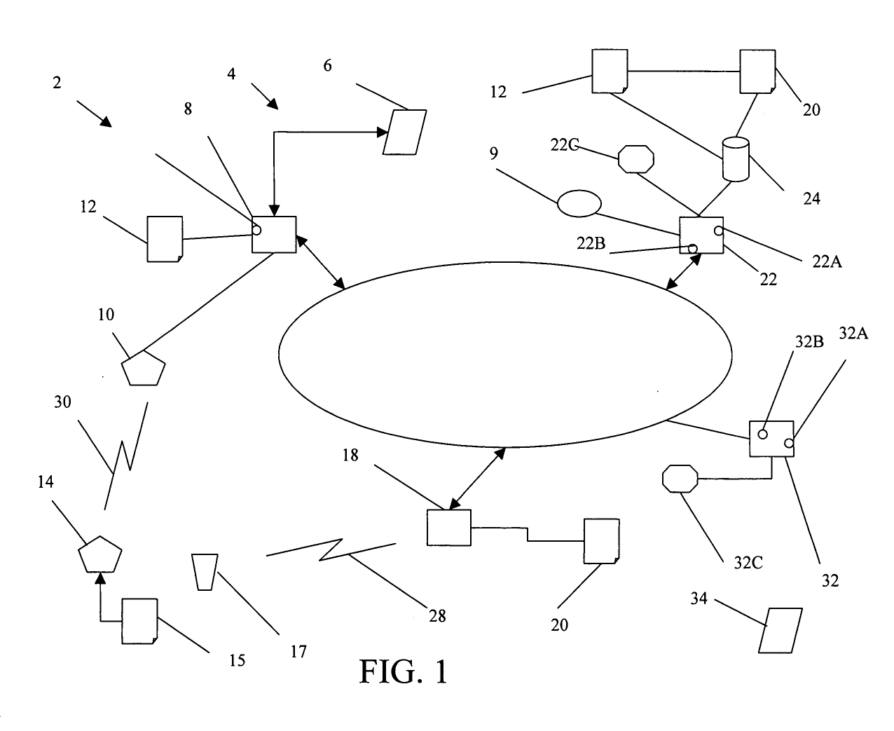

Referring now generally to the drawings, and particularly to FIG. 1, workstation 22 includes a first processor 22A and a second processor 22B, and a read module 22C. The Read 22C module is communicatively coupled with one or both the first processor 22A and the second processor 22B. The read module 22C is selected as compatible with the computer-readable media 6, whereby software code embodied in the computer-readable media may be used by the workstation 22 to program either or both the first processor 22A and the second processor 22B. It is understood that software code provide to enable or support the method of the present invention may be provided in whole or in part to other elements of the communications network, to include record workstation 8, a computer workstation 32, and other suitable computational systems comprised within or communicatively coupled with communications network 2, whereby execution of the method of the present invention may be enabled or supported. More particularly, computer workstation 32 may be enabled to additionally or alternatively execute or support the execution of software code for the purpose of carrying out certain still alternate preferred embodiments of the present invention. Computer workstation 32 includes a first processor 32A and a second processor 32B, and a read module 32C. The Read 32C module 32C is communicatively coupled with one or both the first processor 32A and the second processor 32B. The read module 32c is selected as compatible with the computer-readable media 6 or an alternate computer-readable media 34, whereby software code embodied in the computer-readable media may be used by or delivered to the workstation 32 to program either or both the first processor 32A and the second processor 32B.

Those skilled in the art will appreciate that various adaptations and modifications of the just-described preferred embodiments can be configured without departing from the scope and spirit of the invention. Other suitable fabrication, manufacturing, assembly, wire bonding and test techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

1. A method to enable a signer to append an electronic signature to a document, the method comprising:
generating a printed document to the signer, the printed document containing characters sensually observable to the signer, the characters representing information;
calculating a checksum, the checksum calculated at least in part from the information;
providing the checksum to the signer;
allowing the signer to examine the characters of the document;
enabling the signer to make an electronic record by means of a voice input;
accepting a first voice input from the signer, the first voice input including a verbalization of the checksum; and
making a first electronic record of the first voice input.

2. The method of claim 1, wherein the method further comprises:
storing the first electronic record in an electronic database; and
associating the electronic record with the information of the document.

3. The method of claim 2, wherein the method further comprises:
assigning a serial number to the document;
informing the signer of the serial number;
accepting a second voice input from the signer, the second voice input including a verbalization of the serial number;
making a second electronic record of the second voice input; and
associating the second electronic record with the information of the document.

4. The method of claim 3, wherein the second electronic record is comprised within the first electronic record.

5. The method of claim 1, wherein the signer provides the first voice input by means of a telephone.

6. The method of claim 1, wherein the method is comprised within an electronic workflow.

7. The method of claim 6, wherein the electronic workflow is at least partly executed by means of the Internet.

8. The method of claim 1, wherein the printed document is provided to the signer as a faxed communication, and the characters comprise visually observable characters.

9. In an electronic recording system, the electronic recording system for receiving voice inputs and recording the voice inputs as electronic records, a method for a signer to issue an electronic signature to a document, the method comprising:
receiving a printed document, the printed document containing characters sensually observable to the signer, the characters representing information;
receiving a checksum, the checksum calculated at least in part from the information;
confirming the validity of the information by examining the characters of the document; and
issuing a first voice input to the electronic recording system, the first voice input including a verbalization of the checksum.

10. The method claim 9, wherein the method further comprises:
receiving a serial number associated with the document; and
issuing a second voice input to the electronic recording system, the second voice input including a verbalization of the serial number.

11. The method of claim 9, wherein the signer provides the voice input to the electronic recording system via a telephone.

12. The method of claim 9, wherein the method is comprised within an electronic workflow.

13. The method of claim 9, wherein the electronic recording system generates an electronic record of the first voice input and the electronic record is available via a computer network.

14. The method of claim 13, wherein the computer network comprises the Internet.

15. The method of claim 9, wherein the printed document is a faxed communication and the characters comprise visually observable characters.

16. The method of claim 9, wherein the printed communication is in the format of a death certificate.

17. The method of claim 16, wherein the signer is authorized by law to certify a cause of death.

18. The method of claim 16, wherein the signer is authorized by law to certify a death certificate.

19. The method of claim 15, wherein the printed communication is in the format of a death certificate.

20. The method of claim 19, wherein the signer is authorized by law to certify a death certificate.

21. A system having a computer-readable medium, a computer network, fax systems and telephones, wherein the computer-readable medium carrying one or more sequences of one or more instructions for buffering data, wherein the execution of the one or more sequences of the one or more instructions by one or more processors, causes the one or more processors to perform a method of associating an offline approval of a document by an informant with a checksum, the method comprising:
generating a printed document to the signer via transmission from a first fax system to a second fax system, the printed document printed by the second fax system and containing characters sensually observable to the signer, the characters representing information;
calculating a checksum, the checksum calculated at least in part from the information;
providing the checksum to the signer;
allowing the signer to examine the characters of the document;
enabling the signer to make an electronic record by means of a voice input;
accepting a first voice input from the signer via a telephone, the first voice input including a verbalization of the checksum; and
making a first electronic record of the first voice input.

22. One or more processor readable storage devices having readable code embodied on the processor readable storage devices, the readable code for programming one or more processors one to perform a method of associating an offline approval of a document by an informant with a checksum, the method comprising:
generating a printed document to the signer via transmission from a first fax system to a second fax system, the printed document printed by the second fax system and containing characters sensually observable to the signer, the characters representing information;
calculating a checksum, the checksum calculated at least in part from the information;
providing the checksum to the signer;
allowing the signer to examine the characters of the document;
enabling the signer to make an electronic record by means of a voice input;
accepting a first voice input from the signer via a telephone, the first voice input including a verbalization of the checksum; and
making a first electronic record of the first voice input.
